(19) United States
(12) Patent Application Publication
(10) Pub. No.: US 2026/0246844 A1
(43) Pub. Date: Aug. 20, 2026

(54) INFORMATION EXPOSURE METHOD AND APPARATUS, COMPUTER-READABLE MEDIUM, AND ELECTRONIC DEVICE

(71) Applicant: Tencent Technology (Shenzhen) Company Limited, Shenzhen (CN)

(72) Inventor: Zhuoyun ZHANG, Shenzhen (CN)

(21) Appl. No.: 19/658,049

(22) Filed: Apr. 24, 2026

Related U.S. Application Data
(63) Continuation of application No. PCT/CN2024/131389, filed on Nov. 11, 2024.

(30) Foreign Application Priority Data
Dec. 18, 2023 (CN) 202311751722.6

(51) Int. Cl. H04L 67/141; H04W 24/08; H04W 28/02

(52) U.S. Cl. CPC H04L 67/141; H04W 24/08; H04W 28/0226; H04W 28/0236

(57) ABSTRACT

Embodiments of this application provide an information exposure method performed by an electronic device. The information exposure method includes: generating a first information exposure request, the first information exposure request being configured for requesting a user plane function to expose network information; transmitting the first information exposure request to the user plane function; and receiving the network information returned by the user plane function based on the first information exposure request. In technical solutions in the embodiments of this application, a user-plane-based information exposure capability may be implemented, thereby improving security and efficiency of network information exposure.

### CROSS-REFERENCE TO RELATED APPLICATIONS

This application is a continuation application of PCT Patent Application No. PCT/CN2024/131389, entitled “INFORMATION EXPOSURE METHOD AND APPARATUS, COMPUTER-READABLE MEDIUM, AND ELECTRONIC DEVICE” filed on November 11, 2024, which claims priority to Chinese Patent Application No. 202311751722.6, entitled "INFORMATION EXPOSURE METHOD AND APPARATUS, COMPUTER-READABLE MEDIUM, AND ELECTRONIC DEVICE" filed with the China National Intellectual Property Administration on December 18, 2023, all of which are incorporated herein by reference in their entirety.

### FIELD OF THE TECHNOLOGY

This application relates to the field of computer and communication technologies, and specifically, to an information exposure method and apparatus, a computer-readable medium, and an electronic device.

### BACKGROUND OF THE DISCLOSURE

In a mobile communication network, to implement information interaction between a service function and a mobile core network, the mobile core network may expose network information to an application function (AF). However, with development of mobile communication technologies and increase of user requirements, information exposure between a user equipment (UE) and the mobile core network becomes increasingly important. Therefore, how to implement information exposure between the user equipment and the mobile core network is a technical problem that needs to be resolved urgently.

### SUMMARY

Embodiments of this application provide an information exposure method and apparatus, a computer-readable medium, and an electronic device, to implement a user-plane-based information exposure capability, thereby improving security and efficiency of information (for example, network information) exposure.

Other characteristics and advantages of this application become clear through the following detailed descriptions or may be partially learned through practice of this application.

According to a first aspect, an embodiment of this application provides an information exposure method, performed by a user equipment. The information exposure method includes: generating a first information exposure request, the first information exposure request being configured for requesting a user plane function to expose network information; transmitting the first information exposure request to the user plane function; and receiving the network information returned by the user plane function based on the first information exposure request.

According to a second aspect, an embodiment of this application provides an information exposure method, performed by a user plane function. The information exposure method includes: receiving a first information exposure request transmitted by a user equipment, the first information exposure request being configured for requesting the user plane function to expose network information; and transmitting the network information requested in the first information exposure request to the user equipment.

According to a third aspect, an embodiment of this application provides an information exposure method, performed by a session management function. The information exposure method includes: generating notification information, the notification information being configured for indicating address information of a user plane function performing user-plane-based information exposure with a user equipment; and transmitting the notification information to the user equipment, to cause the user equipment to perform information interaction with the user plane function based on the address information of the user plane function.

According to a fourth aspect, an embodiment of this application provides a non-transitory computer-readable medium, having a computer program stored therein, the computer program, when executed by a processor, implementing the information exposure method according to the foregoing embodiments.

According to a fifth aspect, an embodiment of this application provides an electronic device, including: one or more processors; and a storage apparatus, configured to have one or more computer programs stored therein, the one or more computer programs, when executed by the one or more processors, causing the electronic device to implement the information exposure method according to the foregoing embodiments.

In technical solutions provided in some embodiments of this application, a user equipment may generate a first information exposure request, the first information exposure request being configured for requesting a user plane function to expose network information. Then, the user equipment transmits the first information exposure request to the user plane function. Then, the user plane function may transmit the network information requested in the first information exposure request to the user equipment. Alternatively, the user equipment receives a second information exposure request transmitted by the user plane function, the second information exposure request being configured for requesting the user equipment to expose specified information; and the user equipment transmits, to the user plane function, the specified information indicated in the second information exposure request. In the technical solutions in the embodiments of this application, a user-plane-based information exposure capability may be implemented by the user equipment and the user plane function, thereby improving security and efficiency of information (for example, network information) exposure, implementing wider information sharing and cooperation, and improving network performance and quality of service.

The foregoing general descriptions and the following detailed descriptions are merely for exemplary and explanatory purposes, and cannot limit this application.

### BRIEF DESCRIPTION OF THE DRAWINGS

FIG. 1 is a schematic diagram of an exemplary system architecture to which technical solutions in embodiments of this application may be applied.

FIG. 2 is a flowchart of an information exposure method according to an embodiment of this application.

FIG. 3 is a flowchart of an information exposure method according to an embodiment of this application.

FIG. 4 is a flowchart of measuring a downlink transmission delay according to an embodiment of this application.

FIG. 5 is a flowchart of measuring an uplink transmission delay according to an embodiment of this application.

FIG. 6 is a flowchart of measuring an uplink and downlink transmission delay according to an embodiment of this application.

FIG. 7 is a flowchart of an information exposure method according to an embodiment of this application.

FIG. 8 is a flowchart of an information exposure method according to an embodiment of this application.

FIG. 9 is a flowchart of an information exposure method according to an embodiment of this application.

FIG. 10 is a flowchart in which a UPF requests a UE to perform parameter reporting according to an embodiment of this application.

FIG. 11 is a flowchart in which a UE requests a UPF to expose network information according to an embodiment of this application.

FIG. 12 is a flowchart of interaction on a network side according to an embodiment of this application.

FIG. 13 is a block diagram of a network information exposure apparatus according to an embodiment of this application.

FIG. 14 is a block diagram of a network information exposure apparatus according to an embodiment of this application.

FIG. 15 is a block diagram of a network information exposure apparatus according to an embodiment of this application.

FIG. 16 is a schematic structural diagram of a computer system adapted to implement an electronic device according to an embodiment of this application.

### DESCRIPTION OF EMBODIMENTS

Exemplary implementations are described in a more comprehensive manner with reference to the accompanying drawings. However, the exemplary implementations can be implemented in various forms, which are not to be limited to these examples. On the contrary, providing objectives of these implementations is to make this application more comprehensive and complete, and to comprehensively convey the concept of the exemplary implementations to a person skilled in the art.

In addition, the features, structures, or characteristics described in this application may be combined in one or more embodiments in any proper manner. Many specific details are provided in the following descriptions for full understanding of embodiments of this application. However, a person skilled in the art is to be aware that, when implementing technical solutions in this application, not all detailed features in the embodiments need to be used, one or more specific details may be omitted, or another method, element, apparatus, operation, or the like may be used.

In the embodiments of this application, a term "module" or "unit" is a computer program having a predetermined function or a part of a computer program, and works together with another relevant part to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. In other words, these functional entities may be implemented in a form of software, implemented in one or more hardware modules or integrated circuits, or implemented in different networks and/or processor apparatuses and/or microcontroller apparatuses.

The flowcharts shown in the accompanying drawings are merely exemplary descriptions, do not necessarily include all content and operations/steps, and do not necessarily need to be performed in the described sequence. For example, some operations/steps may be further decomposed, and some operations/steps may be combined or partially combined. Therefore, an actual execution sequence may be changed according to an actual case.

A term "a plurality of" mentioned in this specification means two or more. A term "and/or" describes an association relationship for describing associated objects and represents that three relationships may exist. For example, A and/or B may represent the following three cases: Only A exists, both A and B exist, and only B exists. A character "/" indicates an "or" relationship between the associated objects.

In a related technology, information interaction between a user equipment and a mobile core network is implemented by a control plane, and the control plane is responsible for transmitting control signaling and a small amount of user data. Because a bearing capability of the control plane is limited, many information interaction requirements between the user equipment and the mobile core network cannot be satisfied. In addition, information interaction on the control plane has security and privacy protection problems. For example, signaling is prone to malicious attack and tampering.

Based on the foregoing problems, the technical solutions in the embodiments of this application provide a user-plane-based information exposure solution. A user-plane-based information exposure capability may be implemented by a user equipment and a user plane function, thereby improving security and efficiency of information (for example, network information) exposure, implementing wider information sharing and cooperation, and improving network performance and quality of service.

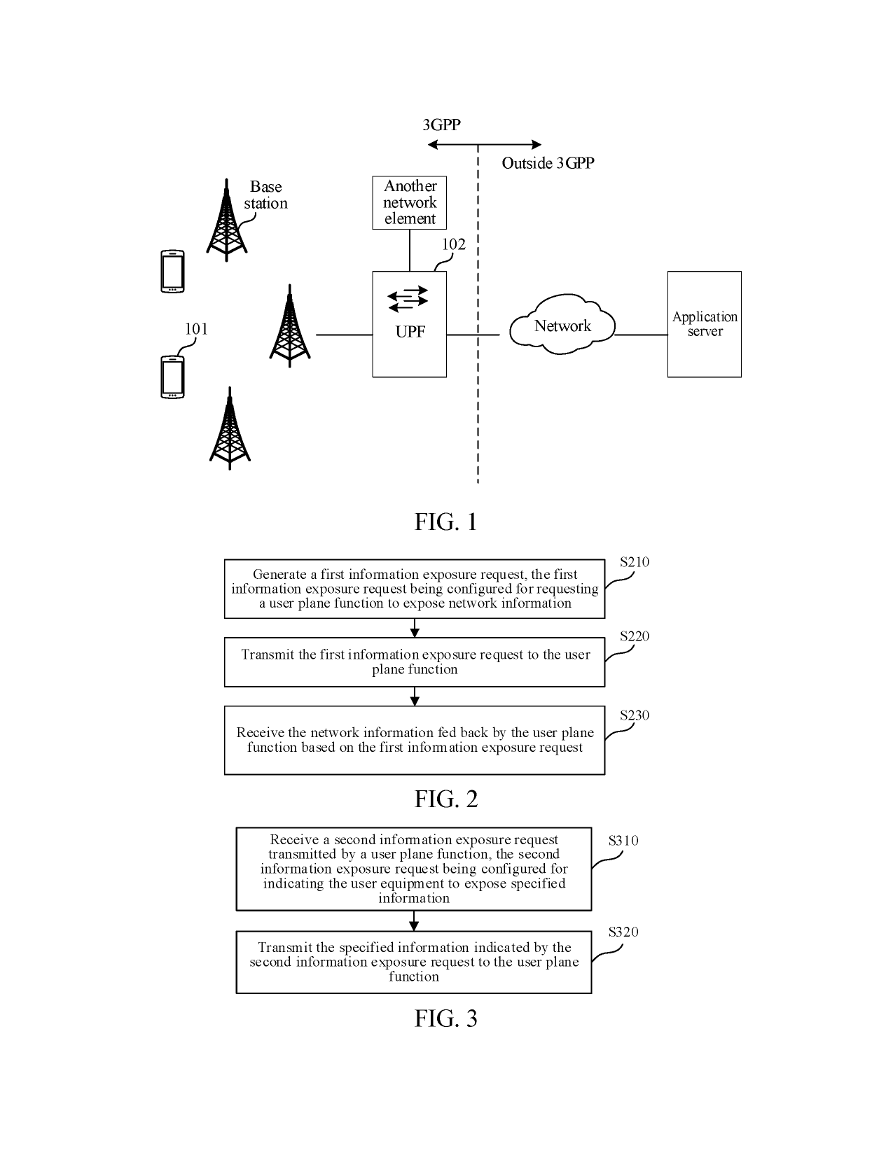

Specifically, as shown in FIG. 1, in a system architecture applied to the technical solutions in the embodiments of this application, a user equipment 101 (the user equipment 101 shown in the figure is used as an example for description) may perform interaction with a user plane function (UPF) 102 via a base station. In a network architecture defined by the 3rd generation partnership project (3GPP) organization, the UPF 102 may perform interaction with another network element, for example, may perform interaction with a session management function (SMF) through an N4 interface. In addition to the network architecture defined by the 3GPP organization, the UPF 102 may perform interaction with an application server (AS) through a network, to implement transmission of service data.

In an embodiment of this application, the user equipment 101 may generate an information exposure request configured for requesting the UPF 102 to expose network information, and transmit the information exposure request to the UPF 102. Then, the UPF 102 may obtain the network information requested by the user equipment 101 based on the information exposure request, and transmit the obtained network information to the user equipment 101. In addition, the user equipment 101 may further receive an information exposure request that is transmitted by the UPF 102 and that is configured for indicating the user equipment 101 to expose specified information (which may include the network information, and other information on a terminal side, for example, a device battery level). Then, the user equipment 101 may transmit, based on the information exposure request transmitted by the UPF 102, the specified information indicated by the information exposure request to the UPF 102.

In the system architecture shown in FIG. 1, information (for example, network information) exposure between the user equipment 101 and the UPF 102 may be implemented by a user plane, thereby facilitating improving security and efficiency of information exposure.

The following describes implementation details of the technical solutions in the embodiments of this application in detail.

FIG. 2 is a flowchart of an information exposure method according to an embodiment of this application. The information exposure method may be performed by a user equipment. Referring to FIG. 2, the information exposure method includes at least S210 to S230, and details are described as follows:

S210: Generate a first information exposure request, the first information exposure request being configured for requesting a user plane function to expose network information.

In some embodiments, the first information exposure request includes the network information to be exposed by the user plane function. For example, the first information exposure request may include at least one of the following information: uplink network congestion information, downlink network congestion information, uplink and downlink network congestion information, an uplink data transmission rate, a downlink data transmission rate, an uplink and downlink data transmission rate, uplink network transmission jitter information, downlink network transmission jitter information, uplink and downlink network transmission jitter information, quality of service (QoS) notification information, and QoS prediction information.

A data transmission direction from the user equipment to an application server is an uplink transmission direction, and a data transmission direction from the application server to the user equipment is a downlink transmission direction.

Uplink network congestion is a phenomenon in which in a network communication process, because a data transmission volume in an uplink exceeds a bearing capability of the uplink, a delay of a data packet in a network increases and a loss rate increases, causing a decline in network performance. Based on this, the uplink network congestion information may include at least one of the following, but is not limited to: a delay, a packet loss rate, and a throughput in the uplink.

Downlink network congestion is a phenomenon in which in a network communication process, because a data transmission volume in a downlink exceeds a bearing capability of the downlink, a delay of a data packet in a network increases and a loss rate increases, causing a decline in network performance. Based on this, the downlink network congestion information may include at least one of the following, but is not limited to: a delay, a packet loss rate, and a throughput in the downlink.

The uplink and downlink network congestion information includes, but is not limited to: the uplink network congestion information and the downlink network congestion information. Alternatively, the uplink and downlink network congestion information includes, but is not limited to: a sum of the uplink network congestion information and the downlink network congestion information. Alternatively, the uplink and downlink network congestion information includes, but is not limited to: an average of the uplink network congestion information and the downlink network congestion information. For explanations and descriptions about the uplink network congestion information and the downlink network congestion information, reference may be made to the foregoing descriptions. Details are not described in this embodiment of this application again.

In this embodiment of this application, definitions of the uplink network congestion information, the downlink network congestion information, and the uplink and downlink network congestion information are not limited.

The uplink data transmission rate is a data transmission rate of the uplink.

The downlink data transmission rate is a data transmission rate of the downlink.

The uplink and downlink data transmission rate includes, but is not limited to: the uplink data transmission rate and the downlink data transmission rate. Alternatively, the uplink and downlink data transmission rate includes, but is not limited to: a sum of the uplink data transmission rate and the downlink data transmission rate. Alternatively, the uplink and downlink data transmission rate includes, but is not limited to: an average of the uplink data transmission rate and the data transmission rate. For explanations and descriptions about the uplink data transmission rate and the downlink data transmission rate, reference may be made to the foregoing descriptions. Details are not described in this embodiment of this application again.

In this embodiment of this application, definitions of the uplink data transmission rate, the downlink data transmission rate, and the uplink and downlink data transmission rate are not limited.

Network jitter is a deviation or a delay between arrival time of a data packet and expected arrival time of the data packet in a network transmission process.

The uplink network transmission jitter information is a difference between a maximum value or a minimum value of transmission delays of a plurality of uplink data packets and an average of transmission delays of the uplink data packets.

The downlink network transmission jitter information is a difference between a maximum value or a minimum value of transmission delays of a plurality of downlink data packets and an average of transmission delays of the downlink data packets.

The uplink and downlink network transmission jitter information includes, but is not limited to: the uplink network transmission jitter information and the downlink network transmission jitter information. Alternatively, the uplink and downlink network transmission jitter information includes, but is not limited to: a sum of the uplink network transmission jitter information and the downlink network transmission jitter information. Alternatively, the uplink and downlink network transmission jitter information includes, but is not limited to: an average of the uplink network transmission jitter information and the downlink network transmission jitter information. For explanations and descriptions about the uplink network transmission jitter information and the downlink network transmission jitter information, reference may be made to the foregoing descriptions. Details are not described in this embodiment of this application again.

In this embodiment of this application, definitions of the uplink network transmission jitter information, the downlink network transmission jitter information, and the uplink and downlink network transmission jitter information are not limited.

The QoS notification information may be notification information transmitted by a base station device when a QoS flow parameter is not satisfied. The QoS flow parameter includes, but is not limited to: a priority, a bandwidth requirement, a delay limit, and a packet loss rate tolerance of a QoS flow.

In this embodiment of this application, definitions of the QoS notification information and the QoS flow parameter are not limited.

The QoS prediction information is information for predicting a performance indicator (for example, response time, a packet loss rate, or a throughput) and quality of service (for example, user satisfaction and service continuity) of a network service in a future period by collecting and analyzing historical data, real-time data, and possible context information (for example, time or a position) and using methods such as machine learning and statistical analysis.

In this embodiment of this application, a definition of the QoS prediction information is not limited.

In some embodiments, the first information exposure request may further include a transmission condition of the network information, for example, periodic transmission or event-triggered transmission.

If the transmission condition is periodic transmission, the first information exposure request further includes a transmission period of the network information, so that the user plane function may transmit the network information to the user equipment based on the transmission period. For example, the user plane function may transmit the network information to the user equipment when each transmission period ends.

If the transmission condition is event-triggered transmission, the first information exposure request further includes an event of triggering network information transmission, and the event may include a threshold corresponding to the network information to be exposed. For example, the threshold is a threshold of the downlink data transmission rate. In this case, the user plane function may transmit the downlink data transmission rate to the user equipment when the user plane function determines that the downlink data transmission rate is greater than the threshold; or the user plane function may transmit the downlink data transmission rate to the user equipment when the user plane function determines that the downlink data transmission rate is less than the threshold; or the user plane function may transmit the downlink data transmission rate to the user equipment when the user plane function determines that the downlink data transmission rate is equal to the threshold. In other words, when the threshold triggers network information transmission, it may be determined, based on an actual service requirement and further indication information, whether the network information is transmitted when the network information is greater than the threshold, or the network information is transmitted when the network information is less than the threshold, or the network information is transmitted when the network information is equal to the threshold. A specific implementation is not limited in the present disclosure.

In some embodiments, the first information exposure request may further include a service identifier targeted by the information exposure request, where the service identifier is used by the user plane function to determine whether a corresponding service can perform network information exposure. In some embodiments, only when the user plane function determines that the service corresponding to the service identifier can perform network information exposure, the user plane function feeds back network information corresponding to the service to the user equipment.

In some embodiments, the first information exposure request may further include certificate information for authentication, where the certificate information is configured for performing interaction between the user plane function and another core network element, to perform authentication processing on the user equipment. In some embodiments, the network information is fed back to the user equipment only after the authentication on the user equipment succeeds. In some embodiments, the user plane function may perform interaction with a core network element like a network exposure function (NEF) or a unified data management (UDM), to perform authentication processing on the user equipment.

Still referring to FIG. 2, S220: Transmit the first information exposure request to the user plane function.

In some embodiments, before transmitting the first information exposure request to the user plane function, the user equipment needs to obtain address information of the user plane function. In some embodiments, the user equipment may receive notification information transmitted by the session management function, obtain, from the notification information, the address information of the user plane function performing user-plane-based information exposure with the user equipment, and then transmit the first information exposure request to the user plane function based on the address information of the user plane function. In some embodiments, the user equipment may receive key information transmitted by the session management function. The key information is configured for data encryption when the user equipment performs network information interaction with the user plane function.

In some embodiments, when indicating the address information of the user plane function to the user equipment, the session management function may indicate the address information based on session management information (SM information) in a protocol data unit (PDU) session establishment process or a PDU session modification process.

In some embodiments, the user equipment may further transmit capability information of the user equipment to the session management function. In this way, the session management function or another network element (for example, a policy control function) performing interaction with the session management function determines, based on the capability information of the user equipment, that the session management function transmits the notification information (for example, the session management information) including the address information of the user plane function to the user equipment when the user equipment supports user-plane-based information exposure.

In some embodiments, the user equipment may further transmit the key information to the session management function, and the session management function transmits the key information to the user plane function, where the key information is configured for data encryption when the user plane function performs network information exposure interaction with the user equipment.

In some embodiments, the capability information of the user equipment is configured for indicating that the user equipment supports user-plane-based information exposure, or is configured for indicating that the PDU session of the user equipment supports user-plane-based information exposure, or is configured for indicating that a specified QoS flow in the PDU session of the user equipment supports user-plane-based information exposure. In other words, the capability information of the user equipment may indicate, at different granularities, a support situation of the user equipment for user-plane-based information exposure capability.

In some embodiments, the address information of the user plane function may be real address information of the user plane function, or virtual address information corresponding to a real network address of the user plane function. The virtual address information may be a network internal address of the user plane function, and one user plane function may have a plurality of pieces of virtual address information. The virtual address information may be variable, and if the virtual address information changes, the virtual address information needs to be retransmitted to the user equipment.

S230: Receive the network information returned by the user plane function based on the first information exposure request.

In some embodiments, the network information returned by the user plane function corresponds to the network information requested in the first information exposure request. For example, if the user equipment requests the uplink network congestion information by using the first information exposure request, after obtaining the uplink network congestion information, the user plane function feeds back the uplink network congestion information to the user equipment.

A process in which the user plane function obtains the network information requested by the user equipment to be exposed is described in detail in the following embodiment.

The technical solution in the embodiment shown in FIG. 2 describes, from the perspective of the user equipment, the process in which the user equipment requests the user plane function to perform network information exposure. With reference to FIG. 3, the following continues to describe, from the perspective of the user equipment, a process in which the user plane function indicates the user equipment to perform network information reporting.

FIG. 3 is a flowchart of an information exposure method according to an embodiment of this application. The information exposure method may be performed by a user equipment. Referring to FIG. 3, the information exposure method includes at least S310 and S320, and details are described as follows:

S310: Receive a second information exposure request transmitted by a user plane function, the second information exposure request being configured for requesting the user equipment to expose specified information.

In some embodiments, the second information exposure request transmitted by the user plane function may include at least one of the following information indicated to be exposed by the user equipment: battery level information of the user equipment, a transmission situation of the user equipment for an uplink data flow, and delay measurement information between the user equipment and the user plane function. In other words, the information indicated to be exposed by the user equipment in the second information exposure request transmitted by the user plane function may include network information, non-network information on a user equipment side (for example, the battery level information and temperature information), or a part thereof.

In some embodiments, the transmission situation of the user equipment for the uplink data flow may be represented by using a packet error rate (PER) or a PDU set error rate (PSER).

In some embodiments, the delay measurement information between the user equipment and the user plane function may be information configured for assisting the user plane function in performing delay measurement, for example, may be a transmit timestamp and a receive timestamp for a data packet that are configured for measuring delay information. The user equipment may transmit an uplink data packet including timestamp information, or include the timestamp information in an extended field of a packet header of the uplink data packet.

In some embodiments, the second information exposure request may further include a transmission condition of the specified information, for example, periodic transmission or event-triggered transmission.

If the transmission condition is periodic transmission, the second information exposure request may further include a transmission period of the specified information, so that the user equipment may transmit the specified information to the user plane function based on the transmission period. For example, the user equipment may transmit the specified information to the user plane function when each transmission period ends.

If the transmission condition is event-triggered transmission, the second information exposure request may further include an event of triggering specified information transmission, and the event may include a threshold corresponding to the specified information. For example, the threshold is a threshold of the battery level information of the user equipment. In this case, the user equipment may transmit the battery level information to the user plane function when the user equipment determines that the battery level information of the user equipment is greater than the threshold; or the user equipment may transmit the battery level information to the user plane function when the user equipment determines that the battery level information of the user equipment is less than the threshold; or the user equipment may transmit the battery level information to the user plane function when the user equipment determines that the battery level information of the user equipment is equal to the threshold. In other words, when the threshold triggers specified information transmission, it may be determined, based on a service requirement and further indication information, whether the network information is transmitted when the network information is greater than the threshold, or the network information is transmitted when the network information is less than the threshold, or the network information is transmitted when the network information is equal to the threshold. A specific implementation is not limited in the present disclosure.

Still referring to FIG. 3, S320: Transmit specified information indicated in the second information exposure request to the user plane function.

In some embodiments, when transmitting the specified information to the user plane function, the user equipment may perform reporting based on the transmission condition included in the second information exposure request, for example, periodic transmission or event-triggered transmission. The transmitted specified information matches the information indicated in the second information exposure request. For example, if the second information exposure request indicates to expose the battery level information of the user equipment, the user equipment transmits the battery level information to the user plane function based on a reporting condition.

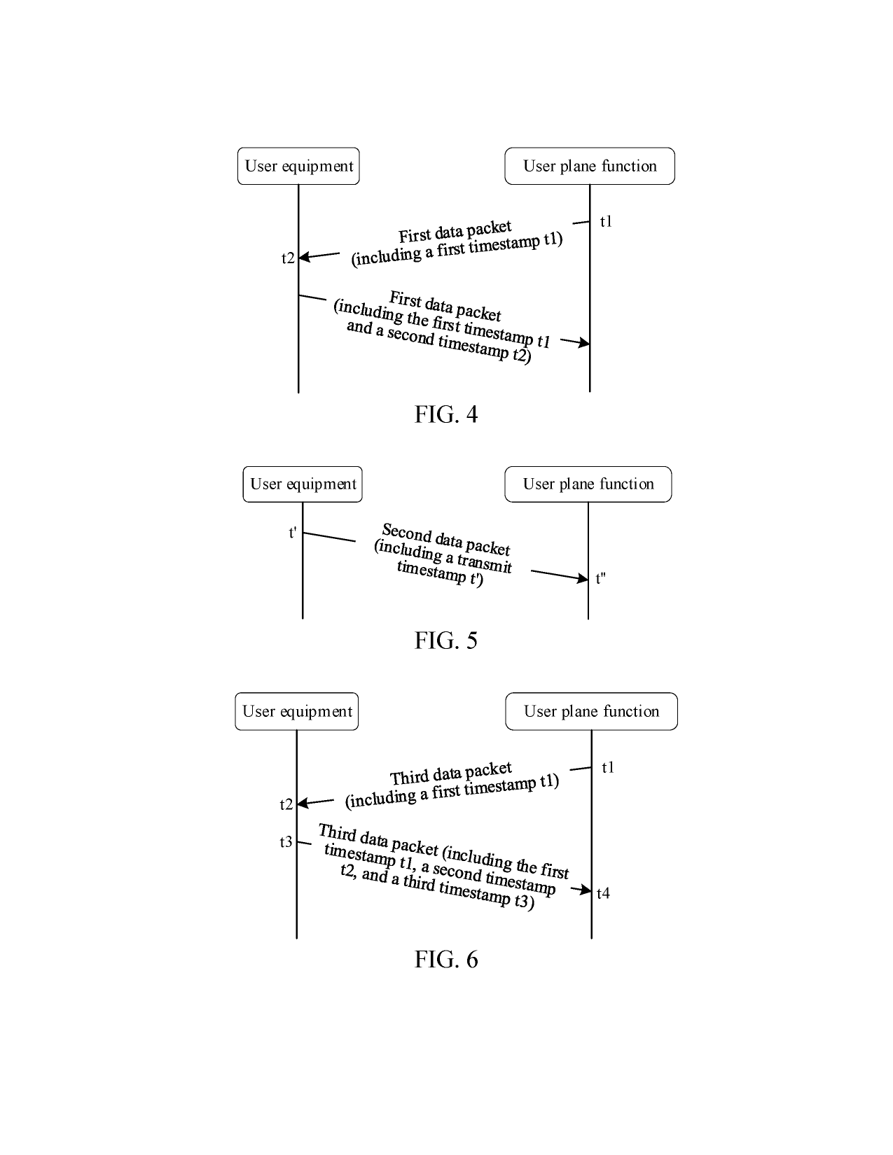

In some embodiments, if the second information exposure request is configured for requesting the user equipment to expose downlink delay measurement information, the user equipment may receive a first data packet that is transmitted by the user plane function and that includes a first timestamp (the first timestamp is a transmit timestamp of the user plane function for the first data packet), add a second timestamp (the second timestamp is a receive timestamp of the user equipment for the first data packet) to the first data packet, and transmit, to the user plane function, the first data packet added with the second timestamp, to cause the user plane function to calculate a downlink transmission delay between the user plane function and the user equipment based on the second timestamp and the first timestamp. Specifically, as shown in FIG. 4, the transmit timestamp of the user plane function for the first data packet is t1, and the receive timestamp of the user equipment for the first data packet is t2. In this way, after the user equipment transmits the first data packet including t1 and t2 to the user plane function, the user plane function may calculate the downlink transmission delay between the user plane function and the user equipment based on t1 and t2. For example, t2–t1 is used as the downlink transmission delay.

In some embodiments, when the second information exposure request is configured for requesting the user equipment to expose uplink delay measurement information, the user equipment may transmit a second data packet including a transmit timestamp to the user plane function, to cause the user plane function to calculate an uplink transmission delay between the user equipment and the user plane function based on the transmit timestamp and a receive timestamp for the second data packet. Specifically, as shown in FIG. 5, the transmit timestamp of the user equipment for the second data packet is t', and the receive timestamp of the user plane function for the second data packet is t''. In this way, the user plane function may calculate the uplink transmission delay between the user equipment and the user plane function based on t' and t''. For example, t''–t' is used as the uplink transmission delay.

In some embodiments, if the second information exposure request is configured for requesting the user equipment to expose uplink and downlink delay measurement information, the user equipment may receive a third data packet that is transmitted by the user plane function and that includes a third timestamp (the third timestamp is a transmit timestamp of the user plane function for the third data packet), and add a fourth timestamp (the fourth timestamp is a receive timestamp of the user equipment for the third data packet) to the third data packet. Then, the user equipment transmits, to the user plane function, the third data packet that is added with the second timestamp and that carries a fifth timestamp when the user equipment transmits the third data packet, to cause the user plane function to calculate an uplink and downlink transmission delay between the user plane function and the user equipment based on the third timestamp, the fourth timestamp, the fifth timestamp, and the receive timestamp for the third data packet. Specifically, as shown in FIG. 6, the transmit timestamp of the user plane function for the third data packet is t1, the receive timestamp of the user equipment for the third data packet is t2, and a transmit timestamp of the user equipment for the third data packet is t3. In this way, after the user equipment transmits the third data packet including t1, t2, and t3 to the user plane function, the user plane function may calculate an uplink and downlink transmission delay between the user plane function and the user equipment based on t1, t2, t3, and a receive timestamp t4 for the third data packet. For example, t4–t3 is used as an uplink transmission delay, t2–t1 is used as a downlink transmission delay, and (t4–t3)+(t2–t1) is used as the uplink and downlink transmission delay.

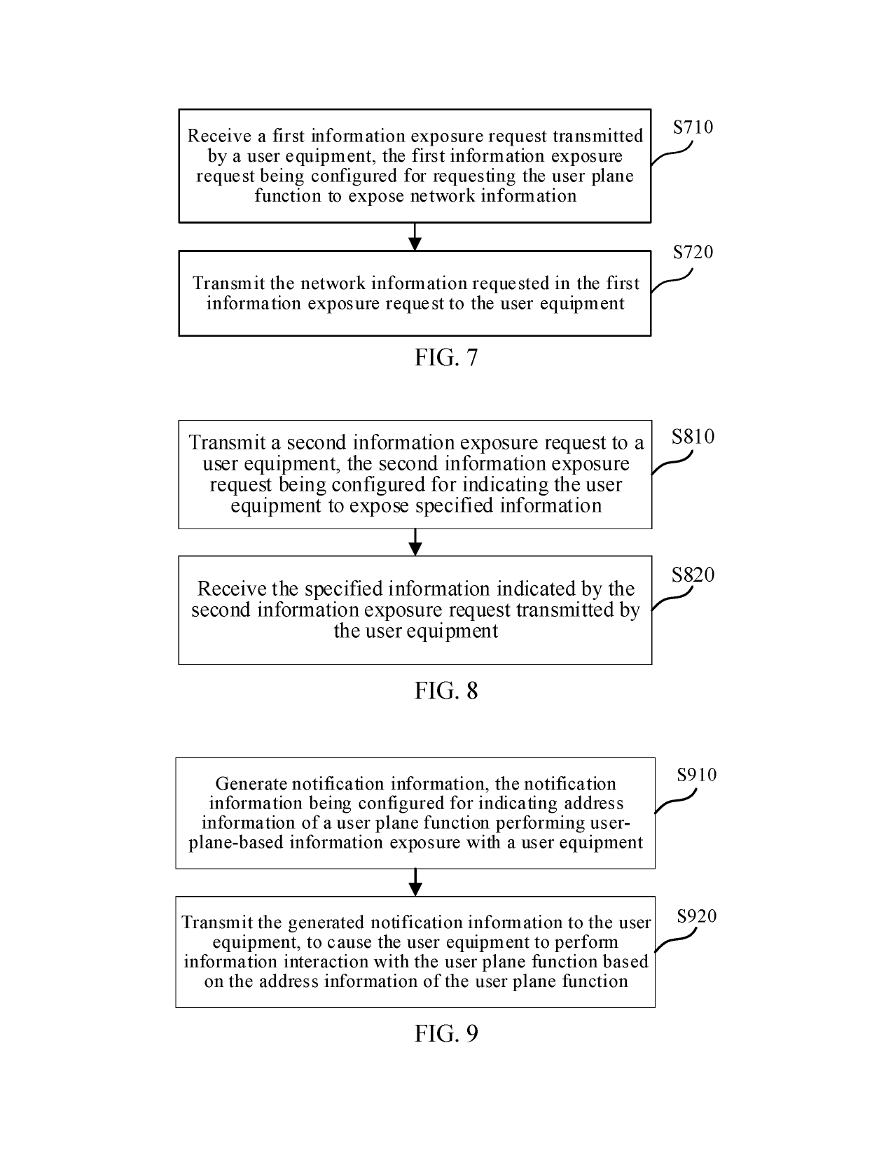

The foregoing embodiment describes implementation details of the technical solutions in the embodiments of this application from the perspective of the user equipment. The following further describes the technical solutions in the embodiments of this application from the perspective of the user plane function with reference to FIG. 7.

FIG. 7 is a flowchart of an information exposure method according to an embodiment of this application. The information exposure method may be performed by a user plane function. Referring to FIG. 7, the information exposure method includes at least S710 and S720, and details are described as follows:

S710: Receive a first information exposure request transmitted by a user equipment, the first information exposure request being configured for requesting the user plane function to expose network information.

In some embodiments, for information included in the first information exposure request, reference may be made to the technical solutions in the foregoing embodiments. To be specific, the first information exposure request may include the network information to be exposed by the user plane function, a transmission condition of the network information, a service identifier targeted by the first information exposure request, certificate information for authentication, and the like. Correspondingly, the user plane function may perform a corresponding operation (for example, periodic transmission or event-triggered transmission, determining whether a corresponding service can perform network information exposure, or performing authentication processing on the user equipment) based on specific content included in the first information exposure request. For details, reference may be made to the technical solutions in the foregoing embodiments. Details are not described herein again.

S720: Transmit the network information requested in the first information exposure request to the user equipment.

In some embodiments, if the first information exposure request is configured for requesting network congestion information, the user plane function may transmit a QoS measurement request to a session management function, so that the session management function transmits the QoS measurement request to a base station device via an access and mobility management, and indicates the base station device to report measured network congestion information to the user plane function. In this way, the user plane function may receive the network congestion information reported by the base station device in response to the QoS measurement request, and further transmit the network congestion information to the user equipment. In some embodiments, the network congestion information may be uplink network congestion information, downlink network congestion information, or uplink and downlink network congestion information.

In some embodiments, if the first information exposure request is configured for requesting QoS notification information, the user plane function may transmit a QoS notification information request to a session management function, so that the session management function may transmit or update QoS configuration information (that is, QoS profile information) including QoS notification control information to a base station device via an access and mobility management. The QoS notification control information is configured for requesting the base station device to transmit the QoS notification information when a QoS flow parameter is uncapable of being satisfied. In this way, the base station device may transmit the QoS notification information to the user plane function when the base station device detects that the QoS flow parameter is uncapable of being satisfied. For example, the base station device may transmit the QoS notification information to the user plane function via a user plane. Alternatively, the base station device may transmit the QoS notification information to the session management function via the access and mobility management, and then the session management function transmits the QoS notification information to the user plane function. After obtaining the QoS notification information, the user plane function may transmit the QoS notification information to the user equipment.

In some embodiments, if the first information exposure request is configured for requesting QoS prediction notification information, the user plane function may transmit a QoS prediction notification information request to a session management function, so that the session management function may transmit or update QoS configuration information (that is, QoS profile information) including QoS prediction notification control information to a base station device via an access and mobility management. The QoS prediction notification control information is configured for requesting the base station device to transmit the QoS prediction notification information (the base station device may transmit the QoS configuration information through prediction before a QoS flow parameter is not satisfied). The QoS prediction notification control information may include notification information that is predicted by the base station device and that cannot be satisfied by the QoS information. and related time information. In this way, the base station device may transmit, through prediction, the QoS prediction notification information to the user plane function. For example, the base station device may transmit the QoS prediction notification information to the user plane function via a user plane. Alternatively, the base station device may transmit the QoS prediction notification information to the session management function via the access and mobility management, and the session management function transmits the QoS prediction notification information to the user plane function. After obtaining the QoS prediction notification information, the user plane function may transmit the QoS prediction notification information to the user equipment.

In some embodiments, if the first information exposure request is configured for requesting QoS prediction information, the user plane function may directly transmit a QoS prediction information request to a network data prediction function (for example, a network data analytics function (NWDAF) or another network element having a network data analysis and prediction function), or transmit the QoS prediction information request to the network data prediction function via a session management function. The network data prediction function transmits the QoS prediction information to the user plane function. For example, the QoS prediction information may be directly transmitted to the user plane function, or may be transmitted to the user plane function via the session management function. Further, after obtaining the QoS prediction information, the user plane function may transmit the QoS prediction information to the user equipment.

In some embodiments, if the first information exposure request is configured for requesting a network transmission rate, the user plane function may measure a network transmission rate of a QoS flow of the user equipment, and transmit the network transmission rate to the user equipment. In some embodiments, the network transmission rate may be an uplink network transmission rate, a downlink network transmission rate, or an uplink and downlink network transmission rate.

In some embodiments, if the first information exposure request is configured for requesting network transmission jitter information, the user plane function may perform interaction with the user equipment to obtain transmission delay information through measurement, calculate the network transmission jitter information based on the transmission delay information, and transmit the network transmission jitter information to the user equipment. In some embodiments, the network transmission jitter information may be uplink network transmission jitter information, downlink network transmission jitter information, or uplink and downlink network transmission jitter information. For a process in which the user plane function performs interaction with the user equipment to measure the transmission delay information, reference may be made to the technical solutions in the foregoing embodiments.

In some embodiments, a process of calculating the network transmission jitter information based on the transmission delay information may include: after transmission delay information of a plurality of data packets is obtained, calculating an average of transmission delays, then calculating a difference between a maximum value or a minimum value of the transmission delays in the plurality of data packets and the average, and using the difference as the network transmission jitter information.

The technical solution in the embodiment shown in FIG. 7 describes, from the perspective of the user plane function, the process in which the user equipment requests the user plane function to perform network information exposure. With reference to FIG. 8, the following continues to describe, from the perspective of the user plane function, a process in which the user plane function indicates the user equipment to perform network information reporting.

FIG. 8 is a flowchart of an information exposure method according to an embodiment of this application. The information exposure method may be performed by a user plane function. Referring to FIG. 8, the information exposure method includes at least S810 and S820, and details are described as follows:

S810: Transmit a second information exposure request to a user equipment, the second information exposure request being configured for requesting the user equipment to expose specified information.

For explanations and descriptions of S810, reference may be made to the explanations and the descriptions of S310. Details are not described in this embodiment of this application again.

S820: Receive the specified information indicated in the second information exposure request transmitted by the user equipment.

In some embodiments, if the second information exposure request is configured for requesting the user equipment to expose downlink delay measurement information, the user plane function may transmit a first data packet including a first timestamp (the first timestamp is a transmit timestamp of the user plane function for the first data packet) to the user equipment. In this way, the user equipment adds a second timestamp (the second timestamp is a receive timestamp of the user equipment for the first data packet) to the first data packet, and then the user equipment transmits, to the user plane function, the first data packet added with the second timestamp, to cause the user plane function to calculate a downlink transmission delay between the user plane function and the user equipment based on the second timestamp and the first timestamp.

In some embodiments, when the second information exposure request is configured for requesting the user equipment to expose uplink delay measurement information, the user plane function may receive a second data packet that is transmitted by the user equipment and that includes a transmit timestamp, and the user plane function calculates an uplink transmission delay between the user equipment and the user plane function based on the transmit timestamp and a receive timestamp for the second data packet.

In some embodiments, if the second information exposure request is configured for requesting the user equipment to expose uplink and downlink delay measurement information, the user plane function may transmit a third data packet including a third timestamp (the third timestamp is a transmit timestamp of the user plane function for the third data packet) to the user equipment. In this way, the user equipment adds a fourth timestamp (the fourth timestamp is a receive timestamp of the user equipment for the third data packet) to the third data packet, and then the user plane function receives the third data packet that is added with the second timestamp and that carries a fifth timestamp when the user equipment transmits the third data packet, to cause the user plane function to calculate an uplink and downlink transmission delay between the user plane function and the user equipment based on the third timestamp, the fourth timestamp, the fifth timestamp, and the receive timestamp for the third data packet.

The foregoing separately describes implementation details of the technical solutions in the embodiments of this application from the perspectives of the user equipment and the user plane function. The following further describes the technical solutions in the embodiments of this application from the perspective of the session management function with reference to FIG. 9.

FIG. 9 is a flowchart of an information exposure method according to an embodiment of this application. The information exposure method may be performed by a session management function. Referring to FIG. 9, the information exposure method includes at least S910 and S920, and details are described as follows:

S910: Generate notification information, the notification information being configured for indicating address information of a user plane function performing user-plane-based information exposure with a user equipment.

In some embodiments, the session management function may generate the notification information and transmit the notification information to the user equipment when the session management function determines that a PDU session of the user equipment supports user-plane-based information exposure. In some embodiments, the session management function may determine, based on capability information reported by the user equipment and capability information transmitted by the user plane function, whether the PDU session supports user-plane-based information exposure; or the session management function may determine, based on policy information transmitted by a policy control function, whether the PDU session supports user-plane-based information exposure.

The session management function may obtain the capability information of the user plane function when the session management function establishes a connection to the user plane function, obtain the capability information of the user plane function when the session management function needs to determine whether the PDU session supports user-plane-based information exposure, or obtain the capability information of the user plane function from another network element, for example, a UDM.

In some embodiments, the address information of the user plane function may be real address information of the user plane function or virtual address information corresponding to a real network address of the user plane function. The virtual address information may be a network internal address of the user plane function, and one user plane function may have a plurality of pieces of virtual address information. The virtual address information may be variable, and if the virtual address information changes, the virtual address information needs to be retransmitted to the user equipment.

In some embodiments, the address information of the user plane function may be applied to each QoS flow included in the PDU session of the user equipment. Alternatively, the address information of the user plane function may be applied to a specified QoS flow included in the PDU session. In other words, all QoS flows in the same PDU session may use address information of the same user plane function for user-plane-based information exposure, or different QoS flows in the same PDU session may use address information of different user plane functions for user-plane-based information exposure.

In some embodiments, the notification information generated by the user plane function may further include port information of the user plane function.

In some embodiments, the notification information generated by the user plane function may further include key information for information interaction between the user equipment and the user plane function. The key information may be configured for encryption and decryption processing on interaction information between the user equipment and the user plane function. The key information may be a symmetric key or an asymmetric key.

S920: Transmit the generated notification information to the user equipment, to cause the user equipment to perform information interaction with the user plane function based on the address information of the user plane function.

In some embodiments, the notification information generated by the session management function may be session management information (that is, SM information) in a PDU session establishment process or a PDU session modification process, that is, the address information of the user plane function performing user-plane-based information exposure with the user equipment is added to the session management information.

For a process in which the user equipment performs information exposure with the user plane function based on the address information of the user plane function, reference may be made to the technical solutions in the foregoing embodiments. Details are not described again.

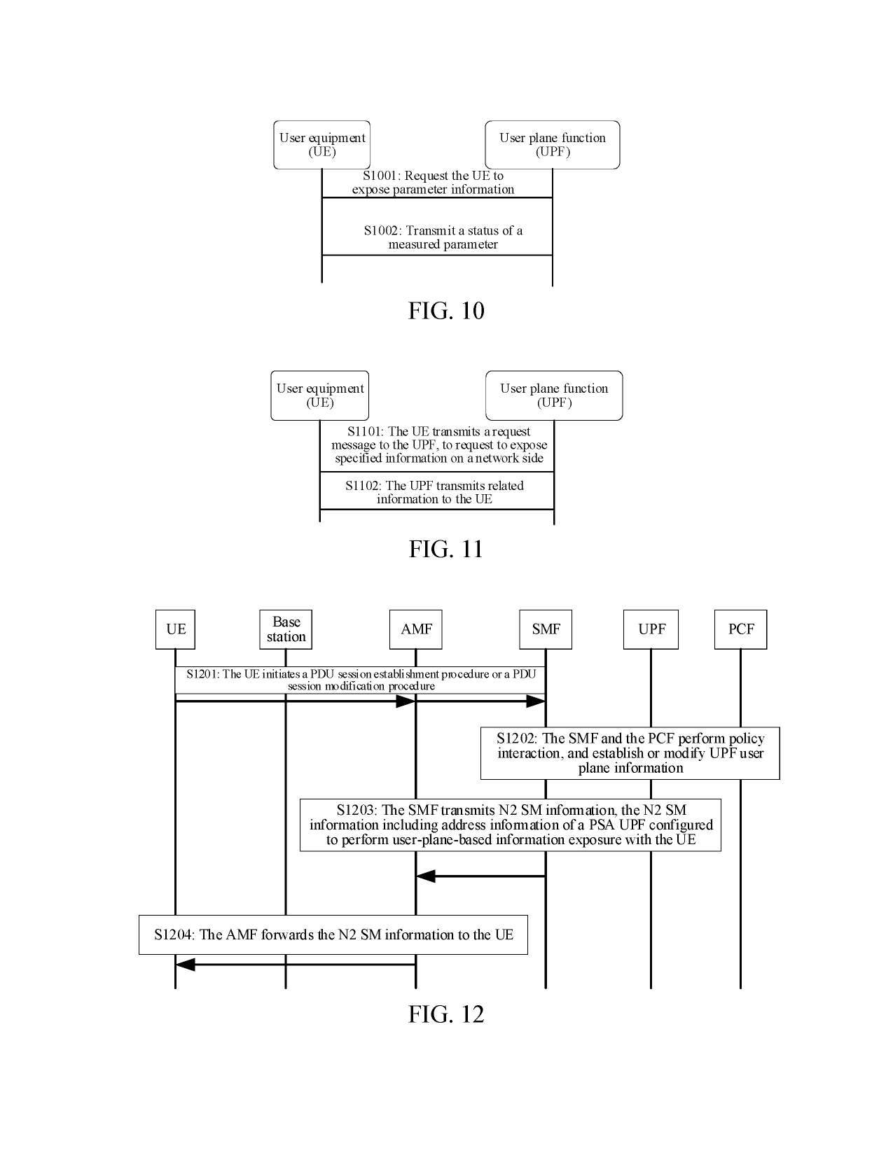

The following describes implementation details of the technical solutions in the embodiments of this application from the perspective of interaction of network elements with reference to FIG. 10 to FIG. 12.

In the embodiments of this application, on a QoS flow (for example, all QoS flows or a specified QoS flow in a PDU session) that needs parameter measurement and information exposure, user-plane-based information exposure may be implemented between a UE and a UPF according to a specified transmission protocol, for example, a multiplexed application substrate over quick user datagram protocol Internet connections (QUIC) encryption (MASQUE) protocol, to implement parameter exposure and information interaction, for the QoS flow, between the UE and a network side. Each interaction procedure between the UE and the UPF in the following embodiments may be information exposure implemented in a QoS flow according to the foregoing specified transmission protocol between the UE and the UPF.

As shown in FIG. 10, a process in which a UPF requests a UE to expose a parameter includes the following operations:

S1001: The UPF requests the UE to expose parameter information.

In some embodiments, the UPF may transmit a request message to the UE, to request the UE to expose the parameter information. The request message may include the following information: a parameter requested for measurement, a transmission condition of the requested parameter, and the like.

In some embodiments, the parameter requested for measurement may include: battery level information of the UE, an uplink data flow processing status (for example, a PER and a PSER), delay measurement information, and the like.

In some embodiments, the transmission condition of the requested parameter may be periodic transmission or event-triggered transmission. If the transmission condition of the requested parameter is periodic transmission, the request message may further include a measurement transmission period. In this way, the UE may transmit the measured parameter when the period ends. If the transmission condition of the requested parameter is event-triggered transmission, the request message may further include information about a threshold. In this way, when determining, based on an actual service requirement and further indication information, that a measurement value exceeds the threshold, is less than the threshold, or is equal to the threshold, the UE may transmit the measured parameter.

S1002: The UE transmits a status of the measured parameter to the UPF.

In some embodiments, if the measured parameter requested by the UPF in S1001 is a downlink transmission delay, the UPF transmits a downlink data packet including a timestamp t1 to the UE, where content of the packet may be null. After receiving the packet, the UE further adds, to the packet, a timestamp t2 at which the UE receives the packet, and then transmits the packet to the UPF. The UPF further calculates a downlink transmission delay: T_{downlink}=t2–t1, of a service flow.

If the measured parameter requested by the UPF in S1001 is an uplink transmission delay, the UE transmits an uplink data packet including a timestamp t3 to the UPF, where content of the packet may be null. After receiving the packet, the UPF calculates an uplink transmission delay: Tᵤₚₗᵢₙₖ=t4–t3, of a service flow based on a timestamp t4 at which the UPF receives the packet.

If the measured parameter requested by the UPF in S1001 is an uplink and downlink transmission delay, the UPF transmits a downlink data packet including a timestamp t1 to the UE, where content of the packet may be null. After receiving the packet, the UE further adds, to the packet, a timestamp t2 at which the UE receives the packet. Then, the UE forwards the packet to the UPF, where the packet further includes a timestamp t3 at which the packet is transmitted. After receiving the packet, based on a timestamp t4 at which the UPF receives the packet, the UPF separately calculates an uplink transmission delay: Tᵤₚₗᵢₙₖ=t4–t3, of a service flow; a downlink transmission delay: T_{downlink}=t2–t1; and a total uplink and downlink transmission delay: (t4–t3)+(t2–t1). In some embodiments, t3 may be equal to t2. In other words, after receiving the packet, the UE forwards the packet to the UPF.

Timestamp information may be added to a packet header of a data packet, or may be added to a payload of the data packet. After obtaining the total uplink and downlink transmission delay through measurement, the UPF may further obtain average uplink and downlink delay information, transmission jitter information, and the like through calculation. In some embodiments, the transmission jitter information may be obtained in the following manner: after transmission delay information of a plurality of data packets is obtained, calculating an average of transmission delays, then calculating a difference between a maximum value or a minimum value of the transmission delays in the plurality of data packets and the average, and using the difference as the transmission jitter information.

As shown in FIG. 11, a process in which a UE requests a UPF to expose network information includes the following operations:

S1101: The UE transmits a request message to the UPF, to request to expose specified information on a network side.

In some embodiments, the request message may include: parameter information requested to be exposed, a condition of the parameter information requested to be exposed, and the like; and the request message may further include service identification information of a service processed by the UE, certificate information of the service for authentication, and the like.

In some embodiments, the parameter information requested by the UE to be exposed may include: network congestion information (which may further include requested uplink congestion information, downlink congestion information, or uplink and downlink congestion information), data transmission rate information on the network side (which may further include requested uplink data transmission rate information, downlink data transmission rate information, or uplink and downlink data transmission rate information), QoS notification information, transmission jitter information (which may further include requested uplink transmission jitter information, downlink transmission jitter information, or uplink and downlink data transmission jitter information), and the like.

In some embodiments, the condition of the parameter information requested to be exposed may be periodic or event-triggered. If the condition of the parameter information requested to be exposed is periodic, the request message may further include a transmission period of a parameter that needs to be exposed. In this way, the UPF transmits a measured parameter to the UE when the period ends. If the condition of the parameter information requested to be exposed is event-triggered, the request message may further include information about a threshold. In this way, when determining, based on an actual service requirement and further indication information, that a measurement value exceeds the threshold, is less than the threshold, or is equal to the threshold, the UPF may transmit measured parameter information to the UE.

In some embodiments, the service identification information and the certificate information of the service for authentication are used by the UPF to further determine whether the service of the UE may request the parameter information. Further, the UPF may perform interaction with another network element, for example, a NEF or a UDM, to request the another network element to perform authentication on a request of the UE.

S1102: The UPF transmits related information to the UE.

In some embodiments, after the authentication on the UE succeeds and the UPF supports measurement and transmission of the related information, the UPF may transmit measurement information based on content requested by the UE and a related condition.

In some embodiments, if the UE requests the network congestion information in S1101, the UPF may transmit a QoS measurement request to an SMF. Based on an existing QoS measurement mechanism, the SMF transmits the QoS measurement request to a base station via an AMF, to request the base station to report congestion information to the UPF, and the UPF transmits the congestion information to the UE.

If the UE requests the QoS notification information in S1101, the UPF needs to transmit a QoS notification information request to an SMF. Based on an existing QoS notification mechanism, the SMF transmits or updates QoS profile information including QoS notification control information to a base station via an AMF, to request the base station to transmit the QoS notification information when a parameter of a QoS flow, for example, a guaranteed flow bit rate (GFBR) cannot be guaranteed. The QoS notification information may be transmitted to the SMF via the AMF, and transmitted by the SMF to the UPF. Alternatively, the base station may directly transmit the QoS notification information to the UPF via a user plane (the base station may generate an uplink data packet, and encapsulate the QoS notification information in a packet header), so that the UPF transmits the QoS notification information to the UE.

In some embodiments, if the UE requests QoS prediction notification information in S1101, a base station may transmit, through prediction, the QoS prediction notification information before a parameter of a QoS flow cannot be guaranteed, and does not need to transmit the QoS prediction notification information when the parameter of the QoS flow cannot be guaranteed.

In some embodiments, if the UE requests QoS prediction information in S1101, the UPF may directly transmit a QoS prediction information request to a network data prediction function (for example, an NWDAF or another network element having a network data analysis and prediction function), or transmit the QoS prediction information request to the network data prediction function via an SMF. The network data prediction function transmits the QoS prediction information to the UPF (for example, directly transmits the QoS prediction information to the UPF or transmits the QoS prediction information to the UPF via the SMF), so that after obtaining the QoS prediction information, the UPF may transmit the QoS prediction information to the UE.

If the UE requests network transmission rate information in S1101, the UPF may measure network transmission rate information of a QoS flow, and transmit the measured network transmission rate information to the UE.

If the UE requests network transmission jitter information in S1101, the UPF may perform measurement and calculation in the manner based on the timestamp in the foregoing embodiments, and transmit the network transmission jitter information obtained through calculation to the UE.

In an embodiment of this application, there are also optimization manners in some other aspects for a process of user-plane-based information exposure performed between the UE and the UPF. Specifically, in a PDU session establishment procedure or a PDU session modification procedure, the SMF may determine whether a PDU session of the UE supports user-plane-based information exposure. If the PDU session of the UE supports user-plane-based information exposure, the SMF may include, in N2 SM information, address information of a PDU session anchor (PSA) UPF configured to perform user-plane-based information exposure with the UE. The address information may be an IP address, and may further include port number information.

In some embodiments, based on a PDU session parameter, capability information of the UPF for whether to support user-plane-based information exposure, and capability information reported by the UE for whether to support user-plane-based information exposure, the SMF may determine whether the PDU session of the UE supports user-plane-based information exposure. Alternatively, the SMF may report the information to a policy control function (PCF). The PCF decides whether the PDU session of the UE supports user-plane-based information exposure, and indicates, to the SMF according to a policy control and charging (PCC) rule, whether the PDU session of the UE supports user-plane-based information exposure. In some embodiments, the PDU session parameter may include information such as a data network name (DNN) and a network slice.

In some embodiments, when initiating the PDU session establishment procedure or the PDU session modification procedure, the UE may further include indication information, to indicate whether the PDU session supports user-plane-based information exposure, or whether a specified QoS flow in the PDU session supports user-plane-based information exposure.

In some embodiments, the address information of the PSA UPF may be one piece of virtual address information corresponding to the UPF. When receiving a data packet of the address information, the UPF may parse the data packet. The virtual address information may be a network internal address of the UPF, and one UPF may have a plurality of pieces of virtual address information. The virtual address information may be variable, and if the virtual address information changes, the virtual address information needs to be retransmitted to the UE.

In some embodiments, the address information of the PSA UPF performing user-plane-based information exposure with the UE may be configured for all QoS flows in the PDU session, or may be different pieces of address information that are of the PSA UPF performing user-plane-based information exposure with the UE and that are allocated to different QoS flows.

In some embodiments, the SMF may further include information such as a key required for establishing data interaction between the UE and the PSA UPF in the N2 SM information.

Based on the foregoing optimization manners, as shown in FIG. 12, an interaction procedure on a network side according to an embodiment of this application includes the following operations:

S1201: A UE initiates a PDU session establishment procedure or a PDU session modification procedure.

Specifically, using an example in which the UE initiates the PDU session establishment procedure, the UE transmits a PDU session request to an AMF. Then, the AMF selects an SMF configured to establish the PDU session, and the AMF transmits a session management context creation request to the SMF, to request to establish the PDU session.

S1202: The SMF and a PCF perform policy interaction, and establish or modify UPF user plane information.

If user-plane-based information exposure may be performed on a PDU session of the UE, the PCF transmits information about a user-plane-based information exposure policy to the SMF. For example, when determining that user-plane-based information exposure may be performed between the UE and a UPF, the PCF may perform an indication to the SMF according to a PCC rule. The SMF may also determine, based on an internal configuration (for example, session parameter information, whether the UPF supports user-plane-based information exposure, and whether the UE has a user-plane-based information exposure capability), whether the PDU session of the UE supports user-plane-based information exposure.

S1203: If the SMF determines that the PDU session supports user-plane-based information exposure, the SMF transmits N2 SM information to the AMF, the N2 SM information including address information of a PSA UPF configured to perform user-plane-based information exposure with the UE.

S1204: The AMF forwards the N2 SM information to the UE. Then, the UE may obtain the address information of the PSA UPF performing user-plane-based information exposure, to perform an information exposure process described in the foregoing embodiments with the UPF.

In conclusion, in the technical solutions in this embodiment of this application, a user-plane-based information exposure capability may be implemented by a UE and a UPF, thereby improving information exposure security and efficiency, implementing wider information sharing and cooperation, and improving network performance and quality of service.

The following describes apparatus embodiments of this application, which may be configured for performing the information exposure method in the foregoing embodiments of this application. For details not disclosed in the apparatus embodiments of this application, reference is made to the foregoing embodiments of the information exposure method in this application.

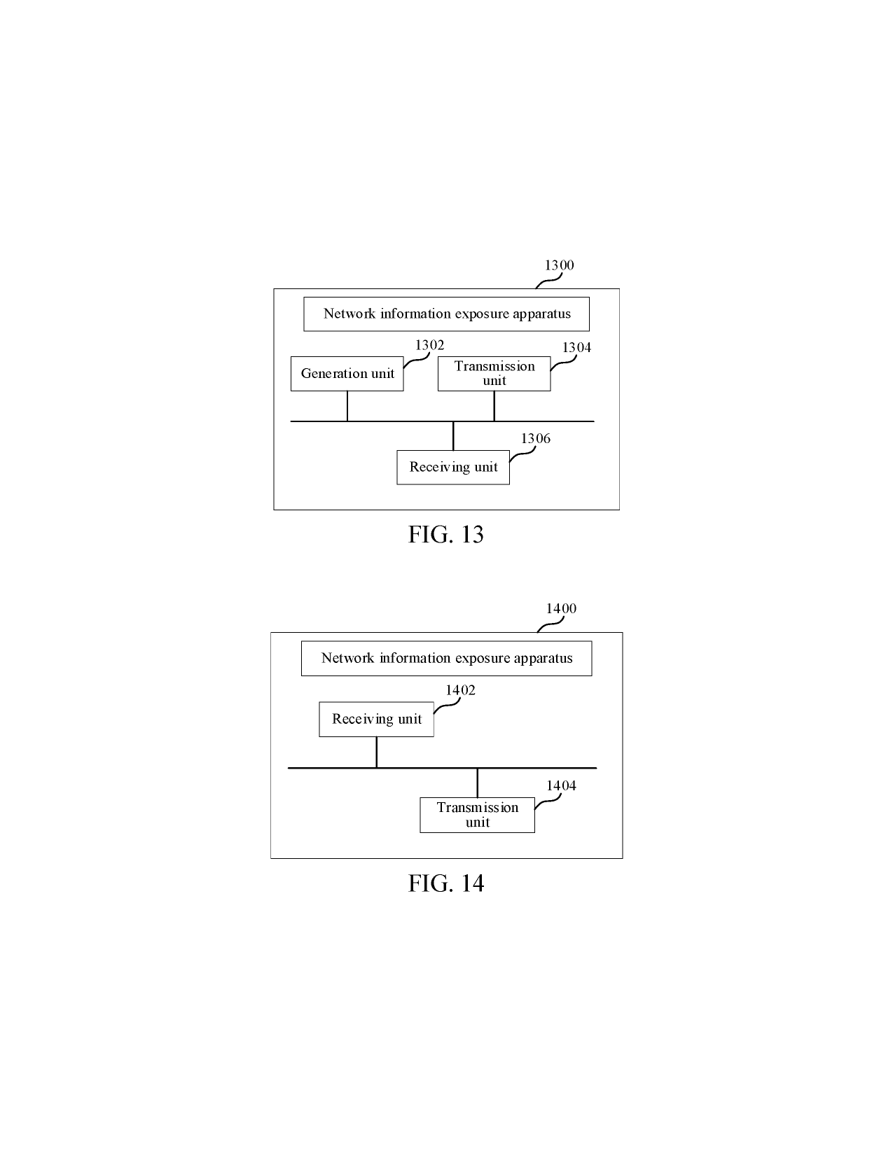

FIG. 13 is a block diagram of a network information exposure apparatus according to an embodiment of this application. The network information exposure apparatus is used in a user equipment.

Referring to FIG. 13, a network information exposure apparatus 1300 according to an embodiment of this application includes: a generation unit 1302, a transmission unit 1304, and a receiving unit 1306.

The generation unit 1302 is configured to generate a first information exposure request, the first information exposure request being configured for requesting a user plane function to expose network information. The transmission unit 1304 is configured to transmit the first information exposure request to the user plane function; and the receiving unit 1306 is configured to receive the network information returned by the user plane function based on the first information exposure request.

In some embodiments of this application, according to the foregoing solutions, the first information exposure request includes the network information to be exposed by the user plane function, and the network information includes at least one of the following: uplink network congestion information, downlink network congestion information, uplink and downlink network congestion information, an uplink data transmission rate, a downlink data transmission rate, an uplink and downlink data transmission rate, uplink network transmission jitter information, downlink network transmission jitter information, uplink and downlink network transmission jitter information, and quality of service (QoS) notification information.

In some embodiments of this application, according to the foregoing solutions, the first information exposure request includes a transmission condition of the network information, where if the transmission condition is periodic transmission, the first information exposure request further includes a transmission period of the network information; and if the transmission condition is event-triggered transmission, the first information exposure request further includes an event of triggering network information transmission, and the event includes a threshold corresponding to the network information to be exposed.

In some embodiments of this application, according to the foregoing solutions, the first information exposure request includes at least one of the following information: a service identifier targeted by the first information exposure request, and certificate information for authentication, where the service identifier is used by the user plane function to determine whether a corresponding service is capable of performing network information exposure; and the certificate information is used by the user plane function to perform interaction with a core network element, to perform authentication processing on the user equipment.

The receiving unit 1306 is further configured to receive a second information exposure request transmitted by a user plane function, the second information exposure request being configured for requesting the user equipment to expose specified information. The transmission unit 1304 is further configured to transmit, to the user plane function, the specified information indicated in the second information exposure request.

In some embodiments of this application, according to the foregoing solutions, the second information exposure request includes at least one of the following information indicated to be exposed by the user equipment: battery level information of the user equipment, a transmission situation of the user equipment for an uplink data flow, and delay measurement information between the user equipment and the user plane function.

In some embodiments of this application, according to the foregoing solutions, the second information exposure request includes a transmission condition of the specified information, where if the transmission condition is periodic transmission, the second information exposure request further includes a transmission period of the specified information; and if the transmission condition is event-triggered transmission, the second information exposure request further includes an event of triggering specified information transmission, and the event includes a threshold corresponding to parameter information indicated to be exposed.

In some embodiments of this application, according to the foregoing solutions, the network information exposure apparatus 1300 further includes: a processing unit, configured to receive, if the second information exposure request is configured for requesting the user equipment to expose downlink delay measurement information, a first data packet that is transmitted by the user plane function and that includes a first timestamp, the first timestamp being a transmit timestamp of the user plane function for the first data packet; add a second timestamp to the first data packet, the second timestamp being a receive timestamp of the user equipment for the first data packet; and transmit, to the user plane function, the first data packet added with the second timestamp, to cause the user plane function to calculate a downlink transmission delay between the user plane function and the user equipment based on the second timestamp and the first timestamp.

In some embodiments of this application, according to the foregoing solutions, the network information exposure apparatus 1300 further includes: a processing unit, configured to transmit, when the second information exposure request is configured for requesting the user equipment to expose uplink delay measurement information, a second data packet including a transmit timestamp to the user plane function, to cause the user plane function to calculate an uplink transmission delay between the user equipment and the user plane function based on the transmit timestamp and a receive timestamp for the second data packet.

In some embodiments of this application, according to the foregoing solutions, the network information exposure apparatus 1300 further includes: a processing unit, configured to receive, if the second information exposure request is configured for requesting the user equipment to expose uplink and downlink delay measurement information, a third data packet that is transmitted by the user plane function and that includes a third timestamp, the third timestamp being a transmit timestamp of the user plane function for the third data packet; add a fourth timestamp to the third data packet, the fourth timestamp being a receive timestamp of the user equipment for the third data packet; and transmit, to the user plane function, the third data packet that is added with the second timestamp and that carries a fifth timestamp when the user equipment transmits the third data packet, to cause the user plane function to calculate an uplink and downlink transmission delay between the user plane function and the user equipment according to the third timestamp, the fourth timestamp, the fifth timestamp, and the receive timestamp for the third data packet.

In some embodiments of this application, according to the foregoing solutions, the receiving unit 1306 is further configured to receive notification information transmitted by a session management function, the notification information indicating address information of the user plane function. The transmission unit 1304 is further configured to transmit the first information exposure request to the user plane function based on the address information of the user plane function.

In some embodiments of this application, according to the foregoing solutions, the notification information includes: session management information in a protocol data unit PDU session establishment process or a PDU session modification process.

In some embodiments of this application, according to the foregoing solutions, the transmission unit 1304 is further configured to: before receiving the notification information transmitted by the session management function, transmit capability information of the user equipment to the session management function, where the capability information of the user equipment is configured for indicating that the user equipment supports user-plane-based information exposure, or is configured for indicating that a PDU session of the user equipment supports user-plane-based information exposure, or is configured for indicating that a specified QoS flow in the PDU session of the user equipment supports user-plane-based information exposure.

FIG. 14 is a block diagram of a network information exposure apparatus according to an embodiment of this application. The network information exposure apparatus is used in a user plane function.

Referring to FIG. 14, a network information exposure apparatus 1400 according to an embodiment of this application includes: a receiving unit 1402 and a transmission unit 1404.

The receiving unit 1402 is configured to receive a first information exposure request transmitted by a user equipment, the first information exposure request being configured for requesting the user plane function to expose network information. The transmission unit 1404 is configured to transmit the network information requested in the first information exposure request to the user equipment.

In some embodiments of this application, according to the foregoing solutions, the transmission unit 1404 is further configured to transmit, if the first information exposure request is configured for requesting network congestion information, a QoS measurement request to a session management function, to cause the session management function to transmit the QoS measurement request to a base station device via an access and mobility management. The receiving unit 1402 is further configured to receive the network congestion information reported by the base station device in response to the QoS measurement request.

In some embodiments of this application, according to the foregoing solutions, the transmission unit 1404 is further configured to transmit, if the first information exposure request is configured for requesting QoS notification information, a QoS notification information request to a session management function, to cause the session management function to transmit or update QoS configuration information including QoS notification control information to a base station device via an access and mobility management, the QoS notification control information being configured for requesting the base station device to transmit the QoS notification information when a QoS flow parameter is uncapable of being satisfied.

The receiving unit 1402 is further configured to receive the QoS notification information, the QoS notification information being transmitted by the base station device to the user plane function via a user plane, or the QoS notification information being transmitted by the base station device to the session management function via the access and mobility management and transmitted by the session management function to the user plane function.

In some embodiments of this application, according to the foregoing solutions, the network information exposure apparatus 1400 further includes: a processing unit, configured to measure, if the first information exposure request is configured for requesting a network transmission rate, a network transmission rate of a QoS flow of the user equipment.

In some embodiments of this application, according to the foregoing solutions, the network information exposure apparatus 1400 further includes: a processing unit, configured to perform, if the first information exposure request is configured for requesting network transmission jitter information, interaction with the user equipment to obtain transmission delay information through measurement, and calculate the network transmission jitter information based on the transmission delay information.

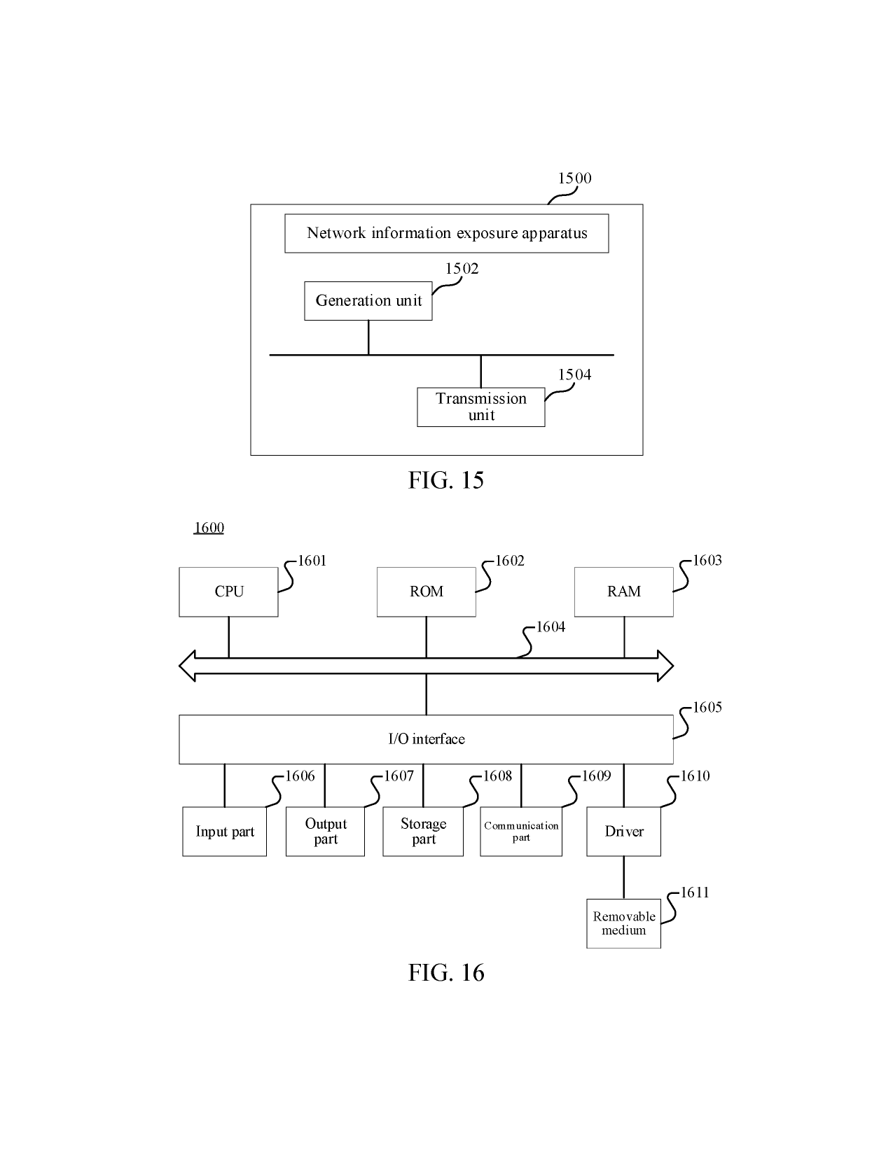

FIG. 15 is a block diagram of a network information exposure apparatus according to an embodiment of this application. The network information exposure apparatus is used in a session management function.

Referring to FIG. 15, a network information exposure apparatus 1500 according to an embodiment of this application includes: a generation unit 1502 and a transmission unit 1504.

The generation unit 1502 is configured to generate notification information, the notification information being configured for indicating address information of a user plane function performing user-plane-based information exposure with a user equipment. The transmission unit 1504 is configured to transmit the notification information to the user equipment, to cause the user equipment to perform information interaction with the user plane function based on the address information of the user plane function.

In some embodiments of this application, according to the foregoing solutions, the generation unit 1502 is configured to generate the notification information when determining that a PDU session of the user equipment supports user-plane-based information exposure.

In some embodiments of this application, according to the foregoing solutions, the generation unit 1502 is further configured to determine, based on capability information reported by the user equipment and capability information transmitted by the user plane function, whether the PDU session supports user-plane-based information exposure; or determine, based on policy information transmitted by a policy control function, whether the PDU session supports user-plane-based information exposure.

In some embodiments of this application, according to the foregoing solutions, the notification information further includes port information of the user plane function.

In some embodiments of this application, according to the foregoing solutions, the address information of the user plane function is virtual address information, the virtual address information corresponding to a real network address of the user plane function.

In some embodiments of this application, according to the foregoing solutions, the address information of the user plane function is applied to each QoS flow included in the PDU session of the user equipment; or the address information of the user plane function is applied to a specified QoS flow included in the PDU session.

In some embodiments of this application, according to the foregoing solutions, the notification information further includes key information for information interaction between the user equipment and the user plane function.

FIG. 16 is a schematic structural diagram of a computer system adapted to implement an electronic device according to an embodiment of this application. The electronic device may be the user equipment, the user plane function, or the session management function in the foregoing embodiments.

A computer system 1600 of the electronic device shown in FIG. 16 is merely an example, and is not to bring any limit to the function and use scope of the embodiments of this application.

As shown in FIG. 16, the computer system 1600 may include a central processing unit (CPU) 1601, which may perform various appropriate actions and processing based on a program stored in a read-only memory (ROM) 1602 or a program loaded from a storage part 1608 to a random access memory (RAM) 1603, for example, perform the method described in the foregoing embodiments. The RAM 1603 further has various programs and data required by system operations stored therein. The CPU 1601, the ROM 1602, and the RAM 1603 are connected to each other through a bus 1604. An input/output (I/O) interface 1605 is also connected to the bus 1604.

The following components may be connected to the I/O interface 1605: an input part 1606, including a keyboard, a mouse, and the like; an output part 1607, including a cathode ray tube (CRT), a liquid crystal display (LCD), a speaker, and the like; the storage part 1608, including a hard disk and the like; and a communication part 1609, including a network interface card such as a local area network (LAN) card or a modem. The communication part 1609 performs communication processing through a network such as the Internet. A driver 1610 is also connected to the I/O interface 1605 as required. A removable medium 1611, such as a magnetic disk, an optical disc, a magneto-optical disk, or a semiconductor memory, is installed on the driver 1610 as required, so that a computer program read from the removable medium 1611 is installed into the storage part 1608 as required.

Particularly, according to this embodiment of this application, the foregoing described process with reference to the flowchart may be implemented as a computer software program. For example, an embodiment of this application includes a computer program product, including a computer program carried in a computer-readable medium, the computer program being configured to perform the method shown in the flowchart. In such an embodiment, the computer program may be downloaded and installed, through the communication part 1609, from a network and/or installed from the removable medium 1611. When the computer program is executed by the CPU 1601, various functions defined in the system of this application are performed.

A related unit described in this embodiment of this application may be implemented in a software manner, or implemented in a hardware manner. Alternatively, the described unit may be arranged in a processor. Names of these units do not constitute a limit on the units in a case.

In another aspect, this application further provides a computer-readable medium. The computer-readable medium may be included in the electronic device described in the foregoing embodiments; or the computer-readable medium may exist alone and is not assembled into the electronic device. The computer-readable medium carries one or more computer programs, and when the one or more computer programs are executed by the electronic device, the electronic device is caused to implement the method described in the foregoing embodiments.

According to the descriptions of the foregoing implementations, a person skilled in the art can easily understand that the exemplary implementations described herein may be implemented by software, or may be implemented by combining the software with necessary hardware. Therefore, the technical solutions according to the implementations of this application may be implemented in a form of a software product. The software product may be stored in a non-volatile storage medium (which may be a CD-ROM, a USB flash drive, a removable hard disk, or the like) or on a network, and includes several instructions to cause an electronic device to perform the method according to the implementations of this application.

For example, if the electronic device may be a user equipment, the user equipment may perform the information exposure method shown in FIG. 2 or FIG. 3. For another example, if the electronic device may be a user plane function, the user plane function may perform the information exposure method shown in FIG. 7 or FIG. 8. For another example, if the electronic device may be a session management function, the session management function may perform the information exposure method shown in FIG. 9.

After considering this specification and practicing the implementations disclosed herein, the person skilled in the art easily conceives of other implementations of this application. This application is intended to cover any variation, use, or adaptive change of this application. These variations, uses, or adaptive changes follow the general principles of this application and include common knowledge or common technical means in the art, which are not disclosed in this application.

What is claimed is:

1. An information exposure method performed by an electronic device acting as a user equipment, the method comprising:
generating a first information exposure request, the first information exposure request being configured for requesting a user plane function to expose network information;
transmitting the first information exposure request to the user plane function; and
receiving the network information from the user plane function based on the first information exposure request.

2. The method according to claim 1, wherein the network information comprises at least one of the following:
uplink network congestion information, downlink network congestion information, uplink and downlink network congestion information, an uplink data transmission rate, a downlink data transmission rate, an uplink and downlink data transmission rate, uplink network transmission jitter information, downlink network transmission jitter information, uplink and downlink network transmission jitter information, and quality of service (QoS) notification information.

3. The method according to claim 1, wherein the first information exposure request comprises a transmission condition of the network information, a transmission period of transmitting the network information when the transmission condition is a periodic transmission; and an event of triggering the network information transmission when the transmission condition is event-triggered transmission, and the event comprises a threshold corresponding to the network information to be exposed.

4. The method according to claim 1, wherein the first information exposure request comprises at least one of the following information: a service identifier targeted by the first information exposure request, and certificate information for authentication, wherein
the service identifier is used by the user plane function to determine whether a corresponding service is capable of performing network information exposure; and
the certificate information is used by the user plane function to perform interaction with a core network element, to perform authentication processing on the user equipment.

5. The method according to claim 1, further comprising:
receiving a second information exposure request transmitted by the user plane function, the second information exposure request being configured for requesting the user equipment to expose specified information; and
transmitting, to the user plane function, the specified information indicated in the second information exposure request.

6. The method according to claim 5, wherein the second information exposure request comprises at least one of the following information indicated to be exposed by the user equipment:
battery level information of the user equipment, a transmission situation of the user equipment for an uplink data flow, and delay measurement information between the user equipment and the user plane function.

7. The method according to claim 5, wherein the second information exposure request comprises a transmission condition of the specified information, wherein
the second information exposure request further comprises a transmission period of the specified information when the transmission condition is periodic transmission; and
the second information exposure request further comprises an event of triggering specified information transmission when the transmission condition is event-triggered transmission, and the event comprises a threshold corresponding to parameter information indicated to be exposed.

8. The method according to claim 5, further comprising:
when the second information exposure request is configured for requesting the user equipment to expose downlink delay measurement information, receiving a first data packet transmitted by the user plane function that comprises a first timestamp, the first timestamp being a transmit timestamp of the user plane function for the first data packet;
adding a second timestamp to the first data packet, the second timestamp being a receive timestamp of the user equipment for the first data packet; and
transmitting, to the user plane function, the first data packet added with the second timestamp, to cause the user plane function to calculate a downlink transmission delay between the user plane function and the user equipment based on the second timestamp and the first timestamp.

9. The method according to claim 5, further comprising:
when the second information exposure request is configured for requesting the user equipment to expose uplink delay measurement information, transmitting a second data packet comprising a transmit timestamp to the user plane function to cause the user plane function to calculate an uplink transmission delay between the user equipment and the user plane function based on the transmit timestamp and a receive timestamp for the second data packet.

10. The method according to claim 5, further comprising:
when the second information exposure request is configured for requesting the user equipment to expose uplink and downlink delay measurement information, receiving a third data packet transmitted by the user plane function that comprises a third timestamp, the third timestamp being a transmit timestamp of the user plane function for the third data packet;
adding a fourth timestamp to the third data packet, the fourth timestamp being a receive timestamp of the user equipment for the third data packet; and
transmitting, to the user plane function, the third data packet that is added with the fourth timestamp and that carries a fifth timestamp when the user equipment transmits the third data packet, to cause the user plane function to calculate an uplink and downlink transmission delay between the user plane function and the user equipment based on the third timestamp, the fourth timestamp, the fifth timestamp, and the receive timestamp for the third data packet.

11. The method according to claim 1, further comprising:
receiving notification information transmitted by a session management function, the notification information indicating address information of the user plane function; and
transmitting the first information exposure request to the user plane function based on the address information of the user plane function.

12. An information exposure method performed by an electronic device acting as a user plane function, the method comprising:
receiving a first information exposure request transmitted by a user equipment, the first information exposure request being configured for requesting the user plane function to expose network information; and
transmitting the network information requested in the first information exposure request to the user equipment.

13. The method according to claim 12, further comprising:
when the first information exposure request is configured for requesting network congestion information, transmitting a QoS measurement request to a session management function, to cause the session management function to transmit the QoS measurement request to a base station device via an access and mobility management; and
receiving the network congestion information reported by the base station device in response to the QoS measurement request.

14. The method according to claim 12, further comprising:
when the first information exposure request is configured for requesting QoS notification information, transmitting a QoS notification information request to a session management function, to cause the session management function to transmit or update QoS configuration information comprising QoS notification control information to a base station device via an access and mobility management, the QoS notification control information being configured for requesting the base station device to transmit the QoS notification information when a QoS flow parameter is uncapable of being satisfied; and
receiving the QoS notification information, the QoS notification information being transmitted by the base station device to the user plane function via a user plane, or the QoS notification information being transmitted by the base station device to the session management function via the access and mobility management and transmitted by the session management function to the user plane function.

15. The method according to claim 12, further comprising:
when the first information exposure request is configured for requesting a network transmission rate, measuring a network transmission rate of a QoS flow of the user equipment.

16. The method according to claim 12, further comprising:
when the first information exposure request is configured for requesting network transmission jitter information, performing interaction with the user equipment to obtain transmission delay information through measurement, and calculating the network transmission jitter information based on the transmission delay information.

17. An electronic device, comprising:
one or more processors; and
a memory, configured to have one or more computer programs stored therein, the one or more computer programs, when executed by the one or more processors, causing the electronic device to implement the information exposure method according to claim 1.

18. The electronic device according to claim 17, wherein the first information exposure request comprises a transmission condition of the network information, wherein
the first information exposure request further comprises a transmission period of the network information when the transmission condition is periodic transmission; and
the first information exposure request further comprises an event of triggering network information transmission when the transmission condition is event-triggered transmission, and the event comprises a threshold corresponding to the network information to be exposed.

19. An electronic device, comprising:
one or more processors; and
a memory, configured to have one or more computer programs stored therein, the one or more computer programs, when executed by the one or more processors, causing the electronic device to implement the information exposure method according to claim 12.

20. The electronic device according to claim 19, wherein the information exposure method further comprises:
when the first information exposure request is configured for requesting network congestion information, transmitting a QoS measurement request to a session management function, to cause the session management function to transmit the QoS measurement request to a base station device via an access and mobility management; and
receiving the network congestion information reported by the base station device in response to the QoS measurement request.
